(19) United States
(12) Patent Application Publication
(10) Pub. No.: US 2024/0288991 A1
(43) Pub. Date: Aug. 29, 2024

(54) MACHINE LEARNING BASED RECOMMENDATIONS FOR USER INTERACTIONS WITH MACHINE VISION SYSTEMS

(71) Applicant: ZEBRA TECHNOLOGIES CORPORATION, Lincolnshire, IL (US)

(72) Inventors: Vasantha Bharathi Ayyappan, Chennai (IN); Pinipolu Priyanka, Andhra Pradesh (IN); Ravishankar Patil M J, Karnataka (IN); Giriswaroop H K, Mandya (IN); Pragnesh Kishorbhai Sanchaniya, Bangalore (IN); Harika Jayanthi, Bangalore (IN)

(21) Appl. No.: 18/115,584

(22) Filed: Feb. 28, 2023

(51) Int. Cl. G06F 3/0482; G06F 3/04817; G06T 7/00; G06V 10/141; G06V 10/25

(52) U.S. Cl. CPC G06F 3/0482; G06F 3/04817; G06T 7/0004; G06V 10/141; G06V 10/25

(57) ABSTRACT

Machine learning based recommendations for user interactions with machine vision systems are provided via populating a graphical user interface (GUI) with a first instance of an image of a product captured by a machine vision system; identifying a feature of the product shown in the image that is associated with a criterion for analyzing the product according to a quality assurance test; identifying, via a machine learning model, a tool for assessing the criterion and settings for the tool based on the feature in the image; populating the GUI with a selectable icon that includes a second instance of the image with an overlay produced according to an assessment of the product via the tool configured according to the settings; and in response to receiving a selection of the selectable icon, adding the tool to a job comprising a series of processes for evaluating the product.

### BACKGROUND

Machine vision systems are often used in product acceptance testing, and provide quality control measures that are based on various captured and analyzed images of the products under test. These machine vision systems may be used in addition to or instead of other testing systems based on weight, electrical properties, or the like, and offer a (potentially) more consistent and accurate screening system than human quality assurance personnel can provide. Various features of the product may be tested for, including the presence and content of identifying markers (e.g., barcodes, labels), product color, surface textures, the presence or absence of various components, orientation, and the like. Given the wide array of cues that can be examined visually by a machine vision system, setting up such as system is generally handled by subject matter experts (SMEs) who have detailed understandings of the products being analyzed, the hardware used to collect images of the products, and the software used to perform the analysis from collected images.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 illustrates an example machine vision system and a product under test, according to embodiments of the present disclosure.

FIG. 2 illustrates an example graphical user interface with an acceptable product under test, according to embodiments of the present disclosure.

FIG. 3 illustrates an example graphical user interface with an unacceptable product under test, according to embodiments of the present disclosure.

FIG. 4 is a flowchart of an example method for providing machine learning based recommendations for user interactions with machine vision systems, according to embodiments of the present disclosure.

FIG. 5 illustrates an example computing device, according to embodiments of the present disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

The present disclosure generally relates to machine learning augmentations for graphical user interfaces (GUIs) that provide an improved user experience. Various machine learning models are deployed to provide suggestions to a human user to select from in the GUI to streamline the setup of a machine vision system. A user provides an image of a product to the machine vision system, and the machine learning models provide various recommendation for the tools and/or settings to use to evaluate the product according to previously selected (and trained upon) tools and settings based on recognized features in the image. The user is able to preview the recommendations in action relative to a supplied image of the product, select various recommended tools or setting to add to a job for analyzing the product via the machine vision system, and adjust any recommended settings.

As used herein, the term “job” refers to a set or series of criteria to evaluate a product against to pass or fail inspection. As used herein, the term “tool” refers to a specific analysis to perform according to the criteria of a job. For example, when performing a job to ensure a parcel is properly routed in a postal system, a first criterion may be to determine if a legible delivery address has been provided, and a second criterion may be to determine if sufficient postage is affixed. A first tool to analyze the criterion of legible delivery address may be an optical character recognition (OCR) tool to read a section of the parcel identified as containing an address, and a second tool for presence recognition to determine whether a sufficient number of postage stamps have been applied to the parcel may be operable to evaluate whether to pass the parcel or fail the parcel for forwarding to the addressee. However, additional or alternative tools may be operable to evaluate the parcel according to the same job. Additionally, several instances of the same tool may be applied with various settings so that the same tool may be used multiple times during a job. Returning to the example of the parcel, the first tool may be used to read a different section of the parcel to identify if a return address is present and legible to route the parcel back to the sender if delivery is unsuccessful.

The selection of the various tools, and the settings therefor, can often be a time consuming process when initially setting up a machine vision system to perform a job, and a process that relies on skilled operators to perform. However, by deploying the teachings of the present disclosure, a practitioner can improve the operations of machine vision system control software to more readily set up accurate and useful tools and settings to perform a job. Accordingly, the present disclosure provides improvements in the underlying computer system that offer improved ease-of-use, improved speed of use, greater exposure of underlying computing capabilities to human users, among other benefits.

Examples disclosed herein are directed to a method for performing a series of operations, a system including a processor and a memory including instructions to that when executed by the processor perform a series of operations, a non-transitory computer readable storage device that stores instructions that when executed by a processor perform a series of operations, wherein the operations include: populating a graphical user interface (GUI) with a first instance of an image of a product captured by a machine vision system; identifying a feature of the product shown in the image that is associated with a criterion for analyzing the product according to a quality assurance test; identifying, via a machine learning model, a tool for assessing the criterion and settings for the tool based on the feature in the image; populating the GUI with a selectable icon that includes a second instance of the image with an overlay produced according to an assessment of the product via the tool configured according to the settings; and in response to receiving a selection of the selectable icon, adding the tool to a job comprising a series of processes for evaluating the product.

In some embodiments, the operations further comprise: in response receiving an adjustment to the settings for the tool, replacing suggested values for the setting with user-specified values to the setting; and updating the machine learning model based on the user-specified values.

In some embodiments, the settings include activation commands for a light fixture associated with the machine vision system, the operations further comprising: simulating application of the light fixture in the second instance of image.

In some embodiments, the product shown in the image is provided in a failure state for the feature according to the criterion, wherein the tool and the settings are suggested with a passing state for the feature.

In some embodiments, the tool is at least one of: an optical character recognition bounding region; a barcode recognition bounding region; a feature presence recognition bounding region; and an alignment verification bounding region including at least two features of the product.

In some embodiments, the tool and the setting are provided in the GUI as a combination for selection.

In some embodiments, the operations further comprise: sensing and recommending hardware for at least one of an industrial Ethernet (IE), programmable logic controller, general purpose input output (GPIO), and a file transfer protocol (FTP) server for saving images.

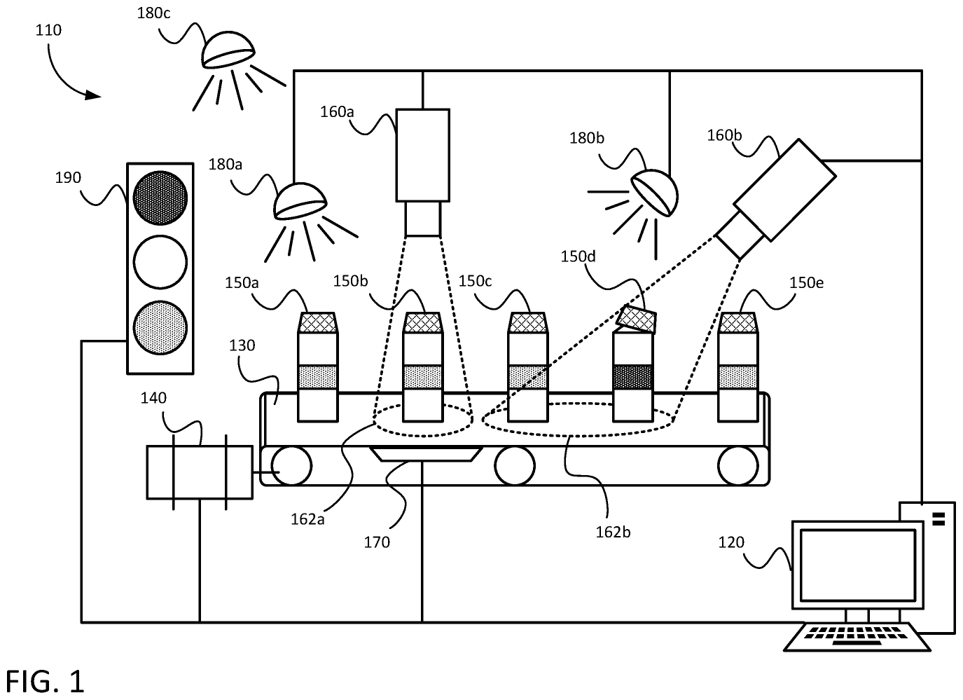

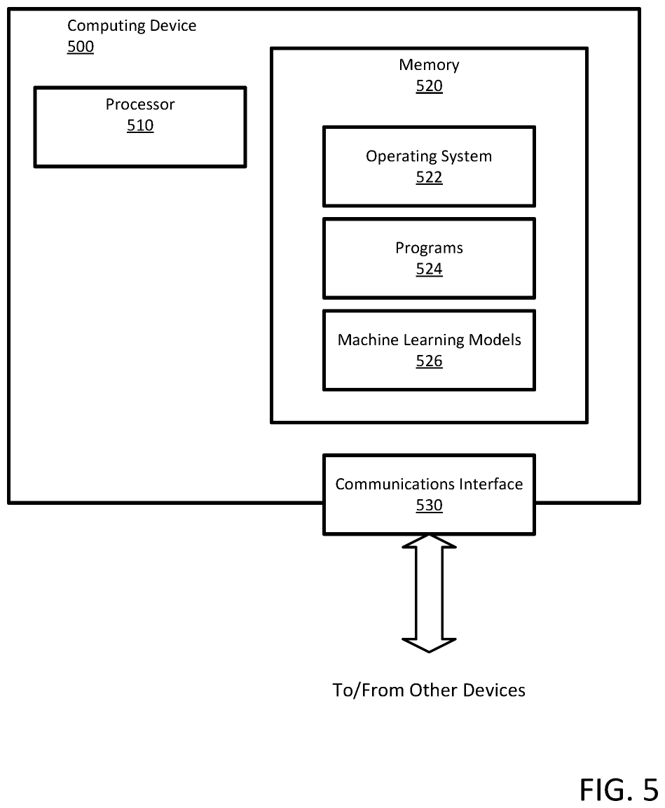

FIG. 1 illustrates an example machine vision system 110 and product 150a-e (generally or collectively, product 150) under test, according to embodiments of the present disclosure. A controller 120, which may be computing device 500 as is described in greater detail in relation to FIG. 5, is in communication with various components of the machine vision system 110 to evaluate the products 150 that are under test, and indicate to operators the results of the analysis. In various embodiments, the controller 120 performs various jobs, which may be set up on the controller 120 or imported from another computing device one which the job was initially created. Similarly, in some embodiments, the controller 120 can store the inputs and results of the analyses locally (e.g., on a hard drive or other memory of the controller 120) or remotely (e.g., on another computing device or memory controller by another computing device).

As illustrated in FIG. 1, the machine vision system 110 includes a pathway 130 on which the product 150 travels to be evaluated. In various embodiments, an operator can manually place the product 150 on the pathway 130, or the pathway 130 may be mechanized to move product 150 through the evaluation. When mechanized, one or more motors 140 under the control of the controller 120 can selectively advance, return, rotate, shift (e.g., between separate sub-units of the pathway 130) are selectively activatable to control how and when the product 150 move during test. When not mechanized, the pathway 130 may be traversed by a product 150 that is self-mobile (e.g., a car under inspection), loaded by a human operator, or fed via gravity. In some embodiments, the pathway 130 includes a conveyer belt, rollers, doors, chutes, slides, robotic armatures, and other means by which the product 150 is moved to one or more designated areas for analysis by various instruments included in the machine vision system 110.

Various visual instruments in the machine vision system 110 can capture images of the products 150 undergoing analysis, which are transferred to the controller 120 to evaluate against a job for the given product 150. For example, one or more cameras 160a-b (generally or collectively, camera 160) can collect still images at specified times, or continuously capture images (e.g., as video) over a time duration. Each camera 160a-b has an associated field of view (FOV) 162a-b (generally or collectively, FOV 162) in which objects are visible to the respective camera 162a-b. Additionally, in some embodiments, the cameras 160 may include or be associated with various positional motors, zoom controls, aperture controls, supplemental light sources (e.g., flashes), and the like that allow for the camera 160 to change the size, shape, lighting, and location of the associated FOV 162. In various embodiments, the cameras 160 include a computing device (such as described in greater detail in regard to FIG. 5), which may be used to pre-process (e.g., crop, color/contrast adjust, add metadata) or cache collected images before transmission to the controller 120.

In various embodiments, non-visual instruments 170 can be incorporated in the machine vision system 110, which may include scales, voltmeters, ohmmeters, ammeters, chemical “sniffers”, light curtains, positional sensors, thermometers, or the like. These non-visual instruments 170 provide additional data to the controller 120 to evaluate the products 150 in addition to the visual features captured in images by the cameras 160.

Various light fixtures 180a-c (generally or collectively, light fixtures 180) may be under the control of the controller 120 (e.g., first and second light fixtures 180a-b) to selectively illuminate some or all of the machine vision system 110 when analyzing products 150, while other light fixtures 180 (e.g., third light fixture 180c) may be outside of the control of the controller 120 (e.g., light fixtures for other machine vision systems, environmental lighting, etc.). In various embodiments, the light fixtures 180 illuminate different portions of the machine vision system 110 or products 150 thereon at varying intensities, times, and using various wavelengths of light (e.g., infrared, visual spectrum, ultraviolet) to improve the visibility of various features of the products 150, while reducing visual interference between the products 150 (e.g., reflections, glare, shadows). The controller 120 therefore is able to adjust the timing, magnitude of illumination, and composition of the light provided by (at least some of) the light fixtures 180 used to illuminate the products 150 and the machine vision system 110 during visual inspection.

Visual inspection of the products 150 allows the controller 120 to identify which products 150 to not meet various test criteria that may not be detectable via the non-visual instruments, or may be ascribed to multiple causes. For example, the fourth product 150d is illustrated with a different appearance than the other products 150 in FIG. 1; having a misaligned cap and a different color label than the other products 150. These defects in construction or appearance may not be detectable via non-visual instruments 170, as the fourth product 150d may have substantially the same weight, temperature, chemical composition, electrical characteristics, etc., as the other products 150, but is not in an acceptable state. In various embodiments, the controller 120 is in communication with an indicator 190, such as a light pole, speaker or other sound producing device, or a pass/fail sorting feature to identify to operators when a product 150 passes or fails inspection, or to separate passing products 150 from failing products 150.

Creating a job for the controller 120 to run for visually inspecting the products 150, however, can be challenging and time consuming given the complexity of the product 150 to be evaluated and the number of components of the machine vision system 110 that can be controlled by the controller 120 to affect the images of the products 150 under test.

Accordingly, the present disclosure provides for the use of machine learning models and graphical user interfaces (GUIs) that provide recommended tools and settings thereof to evaluate various products 150 under test to thereby allow an operator to efficiently create or modify a job using data collected from previously generated jobs and images. When an operator using the machine learning models and GUIs provided herein captures an image of a produce to perform machine vision jobs on, the machine learning model processes the image to suggest multiple possible combinations of tools and settings therefor based on previously observed (e.g., in data used to train the machine learning model) tool combinations and settings, which may be learned from different deployments of different machine vision systems and products under test (e.g., based on product type, industry type, business use case, etc.).

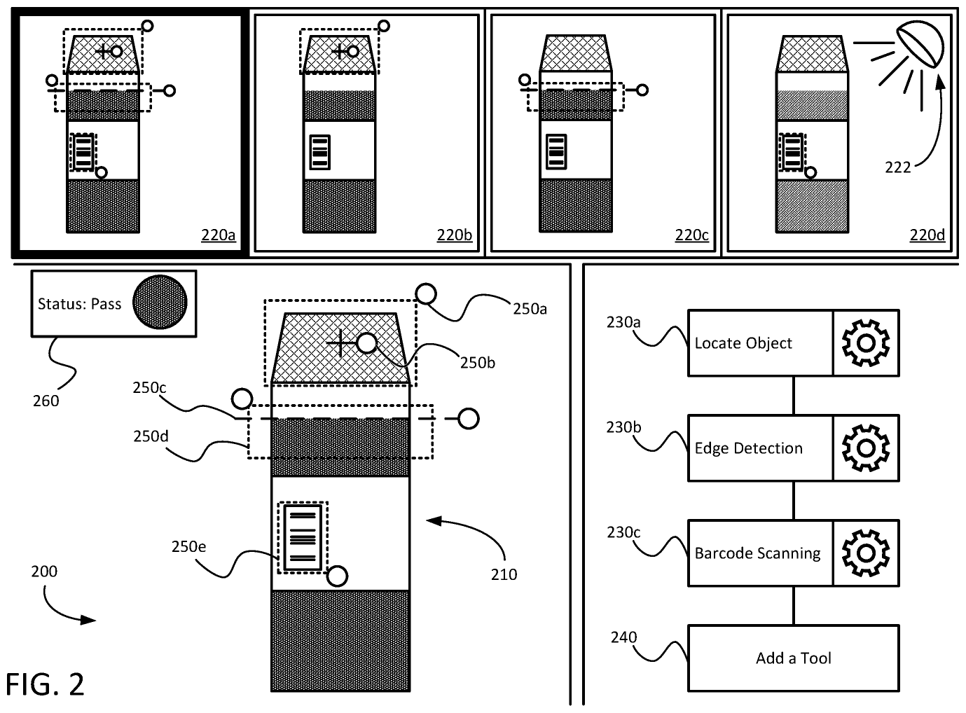

FIG. 2 illustrates an example GUI 200 with an acceptable product under test, according to embodiments of the present disclosure. The GUI 200 displays a first instance 210 of an image of the product captured by the cameras of the machine vision system with various selectable icons 220a-d (generally or collectively, selectable icon 220) that each include a second instance of the image of the product that various analysis tools are applied (or are simulated as being applied) using various suggested settings. Each of the second instances is shown with various overlays indicating the tools that are applied for the suggested job, and at least some of the settings initially recommended for use with those tools.

In some embodiments, when a recommended tool cannot be shown via an overlay, indicators 222 are provided to demonstrate the tools or settings. For example, the fourth icon 220d includes an indicator 222 for a light source being activated to aid in reading a barcode (the reading of which is shown via an overlay for a bounding region recognized as a barcode). Additionally or alternatively to the use of an indicator 222, the fourth icon 220d simulates the application of the light sources by displaying the second instance of the image with an adjusted brightness or contrast, which may be used to show suggested changes in lighting, focus, exposure, and various camera and lighting settings including how to time image acquisition and/or relocate image capture hardware.

A machine learning model determines which tools are presented, the chosen settings for those tools, and the chosen combinations of tools to present in each of the icons 220. The machine learning model can recommend more than or fewer than the example four icons 220 and associated recommendation based on the number of features to analyze identified in the image, an amount of screen space available for icons 220, user preferences for how many recommendations to display at one time, user preferences for how many tools can be combined at one time, available sensors and imaging instruments in the machine vision system, and the like.

When the image of the product is proved as a positive example (e.g., a product that should pass evaluation), the machine learning model identifies the features of the product shown in the image that have been previously used in evaluating other products, and recommends the tools (and settings therefor) to the operator via the icons 220. For example, when the machine learning model identifies that the product is a bottle that includes a visible fluid level, a barcode, and a cap, the machine learning model identifies tools used to evaluate other bottles, objects with visible fluid levels, barcodes, and caps to recommend various tools to the operator.

Additionally, the image of the positive example may be provided as one of a series of positive examples that the machine learning model uses to identify shared features across the differently imaged examples as part of the job, and to discard features that are not shared by the examples as not part of the job. For example, when a series of bottles with different labels (each with a barcode, but with different images) and different colors of caps are provided as positive examples, the machine learning model can avoid recommending tools for label image matching (retaining barcode reading) or cap color matching.

In various embodiments, the tools can include presence/absence determinations and counting for various features, barcode reading, optical character recognition and matching, surface feature identification, defect analysis, image filters, color matching, counting, geometry comparison, and other 2D or 2D machine visions tools. In an automotive industry example, the tools can include pattern matching, measurement (e.g., circle tools), line, contrast/pixel, Barcode reading, and Optical Character Recognition (OCR). In a fastener manufacturing or solar industry example, the tools can include pattern recognition, Measurement, Line, Contrast/Pixel, and counting tools. In a durable consumer goods example (e.g., washing machines), the tools can include locate, pattern matching, Measurement, Line, Contrast/Pixel, and counting tool. In a food and beverages industry example, the tools can include missing cap, quality of cap, surplus material, spill near cap—Locate, Blob tools, Cap Ring inspection—spill—Locate tool, Deformation of bottle—Pattern tool, Quality of container—color, filter, Pattern tools, Inspection of bottom-colored spots—Pattern, Blob tools, Inspection of particles—floating, particles in liquid, Filling Level—Edge detection, Contrast, Reading—OCR, Optical Character Verification (OCV), 1D-2D barcodes, and the like.

In various embodiments, the settings can include lighting settings, image-library matching, relative or absolute positions of bounding boxes or features to match, imaging device settings (aperture, sensitivity, position), correlation with non-image sensors, timing adjustments, speed of motion for the product through the machine vision system, and the like. These settings are also selected, when the image is provided as a positive (e.g., passing) example, based on the contents of the image so that the tools are applied in such a way to generate a pass determination using the currently supplied image.

The recommendations shown in the icons 220 are given as selectable options to the operator to choose from to automatically create a job using the recommended tools and settings for those tools as a single combination, which can then be added to, subtracted from, or otherwise adjusted by the operator to design a job.

As illustrated, an operator has selected the first icon 220a, which results in the GUI 200 generating a job according to the recommendation indicated in the first icon 220a (rather than a job indicated in another icon 220). The GUI 200 provides a series of tool controls 230a-c (generally or collectively, tool control 230) that provide a visual indication of an order in which the various tools are applied during the job. In some embodiments, an operator can drag and drop the tool controls 230 to reorder when the corresponding tools are applied relative to one another during the job, or access the settings for those tools to adjust those settings. An addition control 240 is provided at the end of a sequence of tool controls 230 to allow the operator to add new tools (e.g., from other recommendations shown in the icons 220 or from a tool library), at which time an additional tool control 230 is added to the sequence.

The GUI 200 displays the first instance 210 of the image in a window that shows how the various tools that are part of the job are assessed relative to the product under analysis. In addition to being able to adjust the tools and settings via the tool controls 230, the operator can adjust the applied tooling 250a-e (generally or collectively, applied tooling 250) graphically to adjust the size or location of bounding boxes, locations or presence indicators, locations of centroid indicators, scope of acceptable range indicators, and the like. A status indicator 260 is provided that indicates whether the product shown in the first instance 210 of the image passes or fails the job as currently defined.

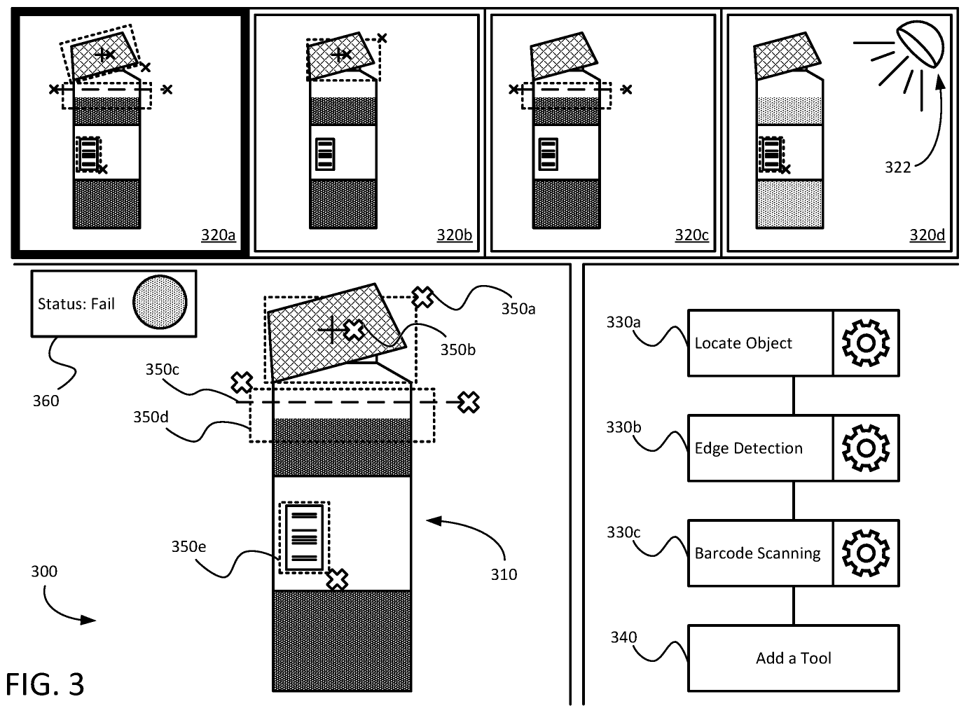

FIG. 3 illustrates an example GUI 300 with an unacceptable product under test, according to embodiments of the present disclosure. The GUI 300 displays a first instance 310 of an image of the product captured by the cameras of the machine vision system with various selectable icons 320a-d (generally or collectively, selectable icon 320) that each include a second instance of the image of the product that various analysis tools are applied (or are simulated as being applied) using various suggested settings. Each of the second instances is shown with various overlays indicating the tools that are applied for the suggested job, and at least some of the settings initially recommended for use with those tools.

In some embodiments, when a recommended tool cannot be shown via an overlay, indicators 322 are provided to demonstrate the tools or settings. For example, the fourth icon 320d includes an indicator 322 for a light source being activated to aid in reading a barcode (the reading of which is shown via an overlay for a bounding region recognized as a barcode). Additionally or alternatively to the use of an indicator 322, the fourth icon 320d simulates the application of the light sources by displaying the second instance of the image with an adjusted brightness or contrast, which may be used to show suggested changes in lighting, focus, exposure, and various camera and lighting settings.

A machine learning model determines which tools are presented, the chosen settings for those tools, and the chosen combinations of tools to present in each of the icons 320. The machine learning model can recommend more than or fewer than the example four icons 320 and associated recommendation based on the number of features to analyze identified in the image, an amount of screen space available for icons 320, user preferences for how many recommendations to display at one time, user preferences for how many tools can be combined at one time, available sensors and imaging instruments in the machine vision system, and the like.

When the image of the product is proved as a negative example (e.g., of a product that should not pass evaluation for one or more reasons), the machine learning model identifies the features of the product shown in the image that have been previously used in evaluating other products, and recommends the tools (and settings therefor) to the operator via the icons 320. For example, when the machine learning model identifies that the product is a bottle that includes a visible fluid level, a barcode, and a cap, the machine learning model identifies tools used to evaluate other bottles, objects with visible fluid levels, barcodes, and caps to recommend various tools to the operator. These tools are provided with recommended settings for what a passing value should be for the various non-passing criteria, based on the contents of the image so that the tools are applied in such a way to generate a fail determination using the currently supplied image, but an estimate of what would generate a pass determination had a positive example been provided.

Additionally, the image of the negative example may be provided with a contrasting positive example or a series of negative examples, which the machine learning model uses to identify what features are outside of an acceptable range and what a suggested acceptable range for the feature is. For example, when provided with a series of images of products with labels that are shown in different non-parallel (relative to an edge of the product or the horizon on the machine vision system) arrangements as negative examples, the machine learning model can identify that label orientation is an evaluation criteria, and may identify a range to parallel (e.g., ±X degrees) that is less than shown in the negative examples as a setting for a label alignment tool to recommend as part of a job. In an additional example, when provided with a positive example of a product having a barcode in a first location and a negative example with a barcode in a second location, the machine learning model can identify the different in the barcode location as an evaluation criteria to include in the job with a barcode presence/location tool having settings configured to pass based on the first location and fail based on the second location. Accordingly, the machine learning model enables an operator to provide various examples in which the pass/fail condition is difficult to place into words or computer instructions, and provides recommendations of tools (and setting therefor) that the operator may have been unaware of or otherwise unable to express in the computer application used to manage the machine vision system, among other benefits, such as faster setup time for jobs on the machine vision system.

The recommendations shown in the icons 320 are given as selectable options to the operator to choose from to automatically create a job using the recommended tools and settings for those tools as a single combination, which can then be added to, subtracted from, or otherwise adjusted by the operator to design a job.

As illustrated, an operator has selected the first icon 320a, which results in the GUI 300 generating a job according to the recommendation indicated in the first icon 320a (rather than a job indicated in another icon 320). The GUI 300 provides a series of tool controls 330a-c (generally or collectively, tool control 330) that provide a visual indication of an order in which the various tools are applied during the job. In some embodiments, an operator can drag and drop the tool controls 330 to reorder when the corresponding tools are applied relative to one another during the job, or access the settings for those tools to adjust those settings. An addition control 340 is provided at the end of a sequence of tool controls 330 to allow the operator to add new tools (e.g., from other recommendations shown in the icons 320 or from a tool library), at which time an additional tool control 330 is added to the sequence.

The GUI 300 displays the first instance 310 of the image in a window that shows how the various tools that are part of the job are assessed relative to the product under analysis. In addition to being able to adjust the tools and settings via the tool controls 330, the operator can adjust the applied tooling 350a-e (generally or collectively, applied tooling 350) graphically to adjust the size or location of bounding boxes, locations or presence indicators, locations of centroid indicators, scope of acceptable range indicators, and the like. A status indicator 360 is provided that indicates whether the product shown in the first instance 310 of the image passes or fails the job as currently defined.

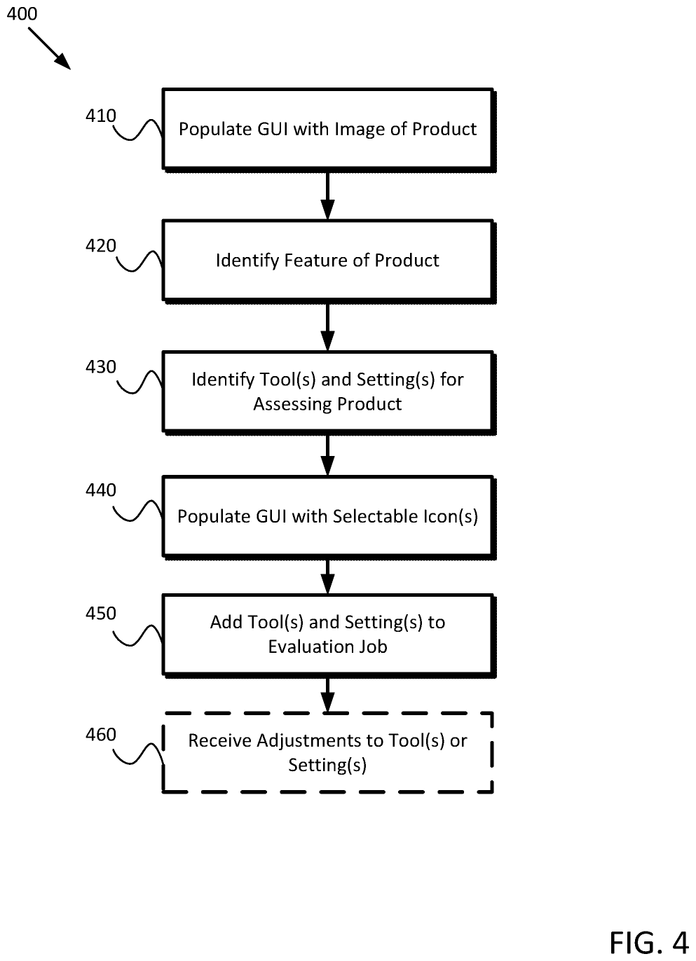

FIG. 4 is a flowchart of an example method 400 for providing machine learning based recommendations for user interactions with machine vision systems, according to embodiments of the present disclosure. Method 400 begins at block 410, where a computing device used to generate jobs for a machine vision system populates a GUI with a first instance of an image of a product captured by the machine vision system. In various embodiments, the image may be part of a series of images supplied as positive examples, negative examples, or a mixture thereof.

At block 420, the machine learning model identifies one or more features of the product shown in the image that is associated with a criterion for analyzing the product according to a quality assurance test. In various embodiments, the machine learning model uses various item identification algorithms or services to identify the type of item that the product is or what various sub-elements of the product are (e.g., a label on the product, a bar code on the label, a lid on the product, a handle on a door, a button on a device, a resistor on a circuit board, etc.), and identifies from previous observations various criteria that have been associated for analysis on that product or sub-element.

At block 430, the machine learning model identifies one or more tools for assessing the criterion identified per block 420 and settings for the tool(s) based on the feature in the image. For example, the tools may include, but are not limited to: an optical character recognition bounding region, a barcode recognition bounding region, a feature presence recognition bounding region, an alignment verification bounding region including at least two features of the product, and other tools for analyzing features of the product. As part of recommending the tools for use in analyzing the product, the machine learning model can sense or identify what hardware is available in the machine vision system to avoid generating recommendations for tools that the machine vision system is incapable of deploying. The hardware can include at least one of an industrial Ethernet (IE), a programmable logic controller, a general purpose input output (GPIO), and a file transfer protocol (FTP) server for saving images to.

Depending on the tools recommended, and the capabilities of the available hardware, the machine learning model can recommend different settings for use with those tools recommended. For example, the machine learning model can recommend values for setting for various cameras, motors, non-visual sensors, and light fixture associated with the machine visions system, to indicate when and how the hardware is to operate when performing a quality assurance test to pass/fail the product using (at least) captured images of the product.

At block 440, the computing device populates the GUI with one or more selectable icons that each include a second instance of the image (displayed per block 410 in the first instance) with an overlay produced according to an assessment of the product via at least one of the identified tools that are configured according to the settings (identified per block 430). Depending on the layout of the GUI, the GUI may concurrently display the first instance and one or more copies of the second instance in corresponding selectable icons. Each of the selectable icons presents a view of the product, based on that shown in the image, with various tools (and associated settings) applied to the image. The icons present a combination of a tool and the settings for that tool, and may present one tool or multiple tools with the associated settings for selection by an operator.

In various embodiments, depending on the tool or the hardware that the setting relates to, the computing device may represent the applied tooling as a overlay in the second instances of the image, or may use various indicators applied to the second images of the image to represent the applied setting. For example, when the setting include activation commands for a light fixture associated with the machine vision system, the computing device can simulate the applied of the light fixture that was not applied in the image as captured to the second instance of the image by increasing a brightness or contrast in the second instance of the image. Similarly, when the setting include deactivation commands for a light fixture associated with the machine vision system, the computing device can simulate the light fixture that was applied in the image as captured as being off in the second instance of the image by decreasing a brightness or contrast in the second instance of the image.

At block 450, in response to receiving a selection of a selectable icon, the computing device adds the tools represented in the selected icon (and the setting recommended therefor) to a job comprising a series of processes for evaluating the product. The computing device updates the display in the GUI to reflect the tools and setting represented in the selectable icon (e.g., populating tool controls, placing overlays for the applied tooling to the first instance of the image, etc.). The operator may then evaluate whether the recommend job meets the desired goals for a quality assurance test for the product depicted in the image. If the operator is satisfied with the recommend job, the computing device saves the job for future use in analyzing product and method 400 may conclude; otherwise, method 400 proceeds to block 460.

At block 460, the computing device (optionally) receives adjustments to the tools or settings for those tools currently included in a job. In various embodiments, the adjustments can include one or more of an addition of a tool, a removal of a tool, or a reordering of tools in the job, and the adjustments to the settings can include new values for the settings for an existing tool or values for a previously un-suggested tools (which may be supplied by the machine learning model or supplied as default values). In response to receiving an adjustment to the setting for a given tool, the computing device replaces the initially suggested values with those received from the user, and can update the machine learning model with the new values as data points for retraining to select better values for the settings (e.g., values preferred by the operators for use with a tool). Accordingly, during a retraining session, the computing device can update the machine learning model based on the user-specified values to thereby provide future recommendations and suggestions that are more like the user-specified values and less like the initially recommended value than prior to updating the machine learning model. Method 400 may conclude when the operator is satisfied with the tools and settings selected for the job, at which time the computing device saves the job for future use in analyzing product.

FIG. 5 illustrates an example computing device 500, such as may be used in a machine vision system 110 according to embodiments of the present disclosure. The computing device 500 includes a processor 510, such as a central processing unit (CPU) and/or graphics processing unit (GPU), application-specific integrated circuit (ASIC), or the like, communicatively coupled with a non-transitory computer-readable storage medium such as a memory 520, e.g., a combination of volatile memory elements (e.g., random access memory (RAM)) and non-volatile memory elements (e.g., flash memory or the like). The memory 520 stores a plurality of computer-readable instructions in the form of applications, including an operating system 522, one or more programs 524 by which the computing device 500 is instructed to perform various operations when the instructions are executed by the processor 510, and one or more machine learning models 526 used by the programs 524, as described herein.

The computing device 500 also includes a communications interface 530, enabling the computing device 500 to establish connections with other computing devices 500 over various wired and wireless networks. The communications interface 560 can therefore include any suitable combination of transceivers, antenna elements, and corresponding control hardware enabling communications across a network. The computing device 500 can include further components (not shown), including output devices such as a display, a speaker, and the like, as well as input devices such as a keypad, a touch screen, a microphone, and the like.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

Certain expressions may be employed herein to list combinations of elements. Examples of such expressions include: “at least one of A, B, and C”; “one or more of A, B, and C”; “at least one of A, B, or C”; “one or more of A, B, or C”. Unless expressly indicated otherwise, the above expressions encompass any combination of A and/or B and/or C.

It will be appreciated that some embodiments may be comprised of one or more specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method, comprising:
populating a graphical user interface (GUI) with a first instance of an image of a product captured by a machine vision system;
identifying a feature of the product shown in the image that is associated with a criterion for analyzing the product according to a quality assurance test;
identifying, via a machine learning model, a tool for assessing the criterion and settings for the tool based on the feature in the image;
populating the GUI with a selectable icon that includes a second instance of the image with an overlay produced according to an assessment of the product via the tool configured according to the settings; and
in response to receiving a selection of the selectable icon, adding the tool to a job comprising a series of processes for evaluating the product.

2. The method of claim 1, further comprising:
in response receiving an adjustment to the settings for the tool, replacing suggested values for the setting with user-specified values to the setting; and
updating the machine learning model based on the user-specified values.

3. The method of claim 1, wherein the settings include activation commands for a light fixture associated with the machine vision system, further comprising:
simulating application of the light fixture in the second instance of image.

4. The method of claim 1, wherein the product shown in the image is provided in a failure state for the feature according to the criterion, wherein the tool and the settings are suggested with a passing state for the feature.

5. The method of claim 1, wherein the tool is at least one of:
an optical character recognition bounding region;
a barcode recognition bounding region;
a feature presence recognition bounding region; and
an alignment verification bounding region including at least two features of the product.

6. The method of claim 1, wherein the tool and the setting are provided in the GUI as a combination for selection.

7. The method of claim 1, further comprising:
sensing and recommending hardware for at least one of an industrial Ethernet (IE), programmable logic controller, general purpose input output (GPIO), and a file transfer protocol (FTP) server for saving images.

8. A system, comprising:
a processor; and
a memory including instructions to that when executed by the processor perform a series of operations, wherein the operations include:
populating a graphical user interface (GUI) with a first instance of an image of a product captured by a machine vision system;
identifying a feature of the product shown in the image that is associated with a criterion for analyzing the product according to a quality assurance test;
identifying, via a machine learning model, a tool for assessing the criterion and settings for the tool based on the feature in the image;
populating the GUI with a selectable icon that includes a second instance of the image with an overlay produced according to an assessment of the product via the tool configured according to the settings; and
in response to receiving a selection of the selectable icon, adding the tool to a job comprising a series of processes for evaluating the product.

9. The system of claim 8, wherein the operations further include:
in response receiving an adjustment to the settings for the tool, replacing suggested values for the setting with user-specified values to the setting; and
updating the machine learning model based on the user-specified values.

10. The system of claim 8, wherein the settings include activation commands for a light fixture associated with the machine vision system, wherein the operations further include:
simulating application of the light fixture in the second instance of image.

11. The system of claim 8, wherein the product shown in the image is provided in a failure state for the feature according to the criterion, wherein the tool and the settings are suggested with a passing state for the feature.

12. The system of claim 8, wherein the tool is at least one of:
an optical character recognition bounding region;
a barcode recognition bounding region;
a feature presence recognition bounding region; and
an alignment verification bounding region including at least two features of the product.

13. The system of claim 8, wherein the tool and the setting are provided in the GUI as a combination for selection.

14. The system of claim 8, wherein the operations further include:
sensing and recommending hardware for at least one of an industrial Ethernet (IE), programmable logic controller, general purpose input output (GPIO), and a file transfer protocol (FTP) server for saving images.

15. A non-transitory computer readable storage device that stores instructions that when executed by a processor perform a series of operations, wherein the operations include:
populating a graphical user interface (GUI) with a first instance of an image of a product captured by a machine vision system;
identifying a feature of the product shown in the image that is associated with a criterion for analyzing the product according to a quality assurance test;
identifying, via a machine learning model, a tool for assessing the criterion and settings for the tool based on the feature in the image;
populating the GUI with a selectable icon that includes a second instance of the image with an overlay produced according to an assessment of the product via the tool configured according to the settings; and
in response to receiving a selection of the selectable icon, adding the tool to a job comprising a series of processes for evaluating the product.

16. The device of claim 15, wherein the operations further include:
in response receiving an adjustment to the settings for the tool, replacing suggested values for the setting with user-specified values to the setting; and
updating the machine learning model based on the user-specified values.

17. The device of claim 15, wherein the settings include activation commands for a light fixture associated with the machine vision system, wherein the operations further include:
simulating application of the light fixture in the second instance of image.

18. The device of claim 15, wherein the product shown in the image is provided in a failure state for the feature according to the criterion, wherein the tool and the settings are suggested with a passing state for the feature.

19. The device of claim 15, wherein the tool is at least one of:
an optical character recognition bounding region;
a barcode recognition bounding region;
a feature presence recognition bounding region; and
an alignment verification bounding region including at least two features of the product.

20. The device of claim 15, wherein the tool and the setting are provided in the GUI as a combination for selection.
